(19) United States
(12) Patent Application Publication
(10) Pub. No.: US 2019/0176089 A1
(43) Pub. Date: Jun. 13, 2019

(54) CARTRIDGE FOR WATER PURIFIER, AND WATER PURIFIER

(71) Applicant: Toray Industries, Inc., Tokyo (JP)

(72) Inventors: Takashi Isobe, Otsu-shi, Shiga (JP); Tsutomu Uesaka, Otsu-shi, Shiga (JP); Naoki Nakashima, Otsu-shi, Shiga (JP)

(73) Assignee: Toray Industries, Inc., Tokyo (JP)

(21) Appl. No.: 15/999,801

(22) PCT Filed: Feb. 17, 2017
(86) PCT No.: PCT/JP2017/005860

§ 371 Date: Aug. 20, 2018

(30) Foreign Application Priority Data
Feb. 19, 2016 (JP) 2016-029882

(51) Int. Cl. B01D 63/02; C02F 1/00; C02F 1/28; C02F 1/44; E03C 1/10

(52) U.S. Cl. CPC B01D 63/02; C02F 1/003; C02F 1/28; C02F 1/44; B01J 20/28028; C02F 2201/006; C02F 2307/06; B01D 2311/2626; B01D 2313/44; E03C 1/10

(57) ABSTRACT

A cartridge for a water purifier has: a granular filter medium; an inner cylinder that supports the granular filter medium from inside, and does not allow the granular filter medium to pass through but allows water to pass through; an outer cylinder that supports the granular filter medium from outside, and does not allow the granular filter medium to pass through but allows water to pass through; a cap member that connects one end of the inner cylinder to one end of the outer cylinder, and that has an opening connected with an inner diameter side channel; an inner cylinder blocking member that blocks the other end of the inner cylinder; and an end portion adhesion material for adhering and fixing the inner cylinder blocking member and the outer cylinder, wherein the inner cylinder blocking member, the outer cylinder, and the end portion adhesion material are arranged so as to integrally block the granular filter medium.

### CROSS REFERENCE TO RELATED APPLICATIONS

This is the U.S. National Phase application of PCT/JP2017/005860, filed Feb. 17, 2017, which claims priority to Japanese Patent Application No. 2016-029882, filed Feb. 19, 2016, the disclosures of these applications being incorporated herein by reference in their entireties for all purposes.

### TECHNICAL FIELD OF THE INVENTION

The present invention relates to a water purifier cartridge for purifying tap water, and a water purifier having the water purifier cartridge built therein.

### BACKGROUND OF THE INVENTION

Conventionally, water purifiers for purifying tap water include a faucet direct connection type water purifier which is directly connected to a spout of a faucet, an under-sink type water purifier which is installed under a sink, etc. In recent years, a water purifier built in a faucet, in which a water purifier cartridge (hereinafter also referred to as cartridge) is built in a shower head of a faucet has been popular. The water purifier built in a faucet is favorable in appearance because it does not need any separate body to be attached to a spout of the faucet. The water purifier built in a faucet has advantages that anyone can replace the cartridge easily without creeping under the sink in order to replace the cartridge. The shower head serving as a spout can be switched between purified water and raw water. Some shower head can'be switched between a direct flow and a shower flow for each of the purified water and the raw water.

As a cartridge of a water purifier built in a faucet, for example, as shown in Patent Document 1, there is a cartridge in which a hollow fiber membrane module is disposed on the downstream side of a molded body of activated carbon. However, in the molded body of activated carbon used in the cartridge, it is necessary to add a binder to the activated carbon when the activated carbon is molded. Thus, there is a problem that the amount of the activated carbon is reduced when molded into a predetermined volume. That is, filtration performance corresponding to the volume of the molded body of activated carbon cannot be exhibited. When the cartridge size is increased, the life of the cartridge can be elongated. However, there is a problem that the faucet which the cartridge is built therein becomes too large to be used easily in a kitchen.

On the other hand, for example, as shown in Patent Document 2, there is a cartridge including an activated carbon portion in which an annular space (activated carbon filling portion) between an outer cylinder and an inner cylinder made of nonwoven fabric alone is filled with granular activated carbon and closed with a closing member. Since the activated carbon portion used in the cartridge contains no binder, it can exhibit filtration performance corresponding to the volume of the activated carbon filling portion.

### PATENT DOCUMENTS

Patent Document 1: JP-A-2002-346550
Patent Document 2: JP-A-2008-194596

### SUMMARY OF THE INVENTION

In the cartridge disclosed in Patent Document 2, the activated carbon filling portion is filled with granular activated carbon and closed with the closing member, and an end portion of the outer cylinder is folded inward at an edge portion of the closing member by an iron or the like so as to be pressed and fixed onto an upper surface of the closing member. In this form, however, the end portion of the outer cylinder pressed and fixed onto the upper surface of the closing member inevitably gets wrinkles. There is found out a problem that the granular activated carbon may leak out from the wrinkles. In addition, since the outer cylinder is much longer than the inner cylinder, there is found out a problem that the granular activated carbon filled into a part different in length between the outer cylinder and the inner cylinder cannot be used effectively. In consideration of the aforementioned problems in the conventional techniques, an object of the present invention is to provide a small-size and long-life water purifier cartridge and a water purifier capable of increasing the filling amount of a granular filter material per unit space, capable of exhibiting filtration performance corresponding to the volume of the granular filter material, and capable of preventing the granular filter material from leaking out.

In order to achieve the above object, a water purifier cartridge of the present invention includes:

a granular filter material;

an inner cylinder which supports the granular filter material from the inside and allows water to pass through but does not allow the granular filter material to pass through;

an outer cylinder which supports the granular filter material from the outside and allows water to pass through but does not allow the granular filter material pass through;

a cap member which couples one end of the inner cylinder with one end of the outer cylinder and has an opening communicating with an inner diameter side channel inside the inner cylinder;

an inner cylinder closing member which closes the other end of the inner cylinder; and

an end portion bonding material which bonds and fixes the inner cylinder closing member to the outer cylinder; wherein:

the inner cylinder closing member, the outer cylinder and the end portion bonding material are disposed to integrally close an opening surface at the other end of the outer cylinder.

In addition, it is preferred that the inner cylinder closing member contacts with an inner circumferential surface of the outer cylinder and has a filling port of the granular filter material.

It is preferred that the water purifier cartridge of the present invention further includes: a filter material closing auxiliary member which closes the filling port; in which:

the inner cylinder closing member, the filter material closing auxiliary member, the outer cylinder and the end portion bonding material are disposed to integrally close the opening surface at the other end of the outer cylinder.

In addition, it is preferred that the filter material closing auxiliary member is a foamed body.

In addition, it is preferred that the end portion bonding material is a hot melt bonding material.

In addition, it is preferred that the end portion bonding material is a polyurethane bonding material.

In addition it is preferred that the end portion bonding material is a silicone bonding material.

In addition, it is preferred that the water purifier cartridge further includes:

a hollow fiber membrane bundle in which hollow fiber membranes are bundled in a U-shape; and

a hollow fiber membrane case which stores the hollow fiber membrane bundle and fixes the hollow fiber membranes at one end of the hollow fiber membrane; in which:

the other end of the hollow fiber membrane case and the cap member are liquid-tightly coupled with each other.

In addition, it is preferred that the inner cylinder is made of a nonwoven fabric.

In addition, it is preferred that the outer cylinder is made of a nonwoven fabric and a thickness of the nonwoven fabric forming the outer cylinder is 0.5 to 1 mm.

In addition, it is preferred that a water purifier cartridge for a water purifier built in a faucet includes a water purifier cartridge according to the above.

In addition it is preferred that in a water purifier built in a faucet, the water purifier cartridge for a water purifier built in a faucet according to the above is disposed removably.

In addition, it is preferred that in a water purifier, the water purifier cartridge according to the above is disposed removably.

The water purifier cartridge according to the present invention includes a granular filter material, an inner cylinder which supports the granular filter material from the inside and allows water to pass through the inner cylinder but does not allow the granular filter material to pass through it, an outer cylinder which supports the granular filter material from the outside and allows water to pass through the outer cylinder but does not allow the granular filter material to pass through it, a cap member which couples one end of the inner cylinder with one end of the outer cylinder and has an opening communicating with the inner cylinder, an inner cylinder closing member which closes the other end of the inner cylinder, and an end portion bonding material which bonds and fixes the inner cylinder closing member to the outer cylinder, in which the inner cylinder closing member, the outer cylinder and the end portion bonding material are disposed to integrally close an opening surface at the other end of the outer cylinder. Here, since the inner cylinder closing member, the outer cylinder and the end portion bonding material are disposed to integrally close the granular filter material as described above, the granular filter material can be prevented from leaking out from the water purifier cartridge. This is because the end portion bonding material used in the water purifier cartridge according to the present invention has flowability when it is manufactured (particularly when the end portion bonding material is applied to the opening portion at the other end of the outer cylinder), and the end portion bonding material is then hardened to lose the flowability. Thus, a gap generated between the inner cylinder closing member and the outer cylinder can be firmly filled with the end portion bonding material having flowability so that the inner cylinder closing member, the outer cylinder and the end portion bonding material can integrally close the opening surface at the other end of the outer cylinder. After the end portion bonding material is hardened, the granular filter material can be prevented from leaking out from the annular space. In addition, since the granular filter material filled into the filter material filling portion is used in the water purifier cartridge according to the present invention, it is not necessary to add a binder for molding the filter material. It is therefore possible to exhibit filtration performance corresponding to the volume of the filter material.

When the inner cylinder closing member contacts with an inner circumferential surface of the outer cylinder and has a filling port of the granular filter material, the granular filter material can be filled in a state where the central axis of the outer cylinder and the central axis of the inner cylinder have been aligned with each other. Thus, the width of the annular space formed by the outer cylinder and the inner cylinder becomes uniform in the radial direction of the water purifier cartridge to make the flow of water uniform. It is therefore possible to sufficiently exhibit the filtration performance of the granular filter material.

When a filter material closing auxiliary member for closing the filling port is provided and the inner cylinder closing member, the filter material closing auxiliary member, the outer cylinder and the end portion bonding material are disposed to integrally close the opening surface at the other end of the outer cylinder, the granular member filled into the annular space can be more surely prevented from leaking to the outside of the annular space.

When the filter material closing auxiliary member is a foamed body, the filter material closing auxiliary member can absorb irregularities of an uppermost portion of the filled granular filter material. Thus, it is possible to secure a space into which the end portion bonding material can be poured. As a result, the end portion bonding material can be brought into tight contact with the outer cylinder without any gap therebetween, and the end portion bonding material can be prevented from flowing into the granular filter material. At the same time, the filter material closing auxiliary member can also contribute to prevention of the granular filter material from leaking.

If the end portion bonding material is a hot melt bonding material, a polyurethane bonding material or a silicone bonding material, the end portion bonding material can have more excellent flowability when manufactured (when applied to the opening portion at the other end of the outer cylinder). Thus, the end portion bonding material can be spread without leaving any gap, and the granular filter material can be surely prevented from leaking. After hardened, the end portion bonding material loses the flowability and has sufficient strength. Therefore, the granular filter material can be surely prevented from leaking even when the water purifier cartridge is installed or even when it is in use. Of each of the hot melt bonding material, the polyurethane bonding material and the silicone bonding material, some material does not elute any harmful substance even if the material contacts with water. Such a material is suitable as a water contact member in the water purifier and can secure safety of purified water.

When the water purifier cartridge further includes a hollow fiber membrane bundle in which hollow fiber membranes are bundled in a U-shape, and a hollow fiber membrane case which stores the hollow fiber membrane bundle and fixes the hollow fiber membranes at one end of the hollow fiber membrane case, and the other end of the hollow fiber membrane case and the cap member are liquid-tightly coupled with each other, bacteria can be caught by the hollow fiber membranes during water passing even if the bacteria enter the activated carbon and proliferate for some reason. Thus, there is no fear that the bacteria are mixed into the purified water.

When each of the inner cylinder and the outer cylinder is made of a nonwoven fabric, the thicknesses of the inner cylinder and the outer cylinder can make thinner so that the filling amount of the granular filter material can be sufficiently increased. Particularly when the thickness of the nonwoven fabric of the outer cylinder is 0.5 mm to 1 mm, the filling amount of the granular filter material can be maximized. Thus, the shape thereof can be retained firmly against water passing resistance.

When the water purifier cartridge is a cartridge for a water purifier built in a faucet, or when the water purifier cartridge is a water purifier built in a faucet from which the water purifier cartridge can be removable, the effect of reduction in size and elongation in life can be more conspicuously exhibited.

Using the water purifier from/to which the water purifier cartridge can be attached/detached, a user can obtain tasty and safe water.

### BRIEF DESCRIPTION OF DRAWINGS

FIG. 1 is a longitudinally sectional conceptual view showing an embodiment of a water purifier cartridge according to the present invention.

FIG. 2 is an enlarged view of an upstream part of the longitudinally sectional conceptual view showing the embodiment of the water purifier cartridge according to the present invention.

FIG. 3 is a partially cutaway sectional conceptual view showing an example of a state in which the water purifier cartridge according to the present invention has been built in a faucet.

FIG. 4 is a perspective conceptual view of a form example of an intermediate cap (cap member) provided in the water purifier cartridge according to the present invention, viewed from the upstream side.

FIG. 5 is a perspective conceptual view of the form example of the intermediate cap (cap member) provided in the water purifier cartridge according to the present invention, viewed from the downstream side.

FIG. 6 is a perspective conceptual view of a form example of a correction cap (inner cylinder closing member) provided in the water purifier cartridge according to the present invention, viewed from the upstream side.

FIG. 7 is a perspective conceptual view of the form example of the correction cap (inner cylinder closing member) provided in the water purifier cartridge according to the present invention, viewed from the downstream side.

FIG. 8 is a perspective conceptual view of a form example of a filter material closing ring (filter material closing auxiliary member) provided in the water purifier cartridge according to the present invention, viewed from the upstream side.

### DETAILED DESCRIPTION OF EMBODIMENTS OF THE INVENTION

An embodiment of a water purifier cartridge according to the present invention will be described with reference to the drawings.

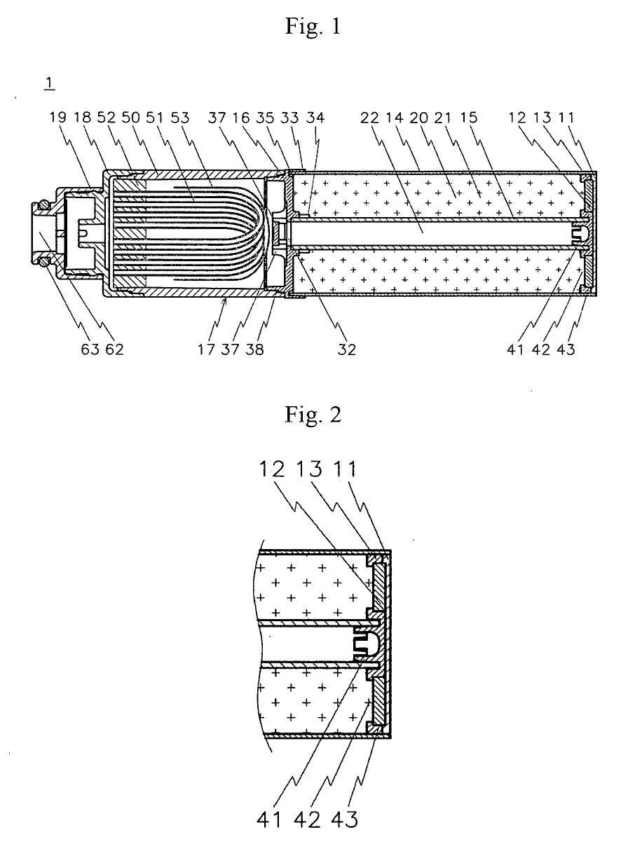

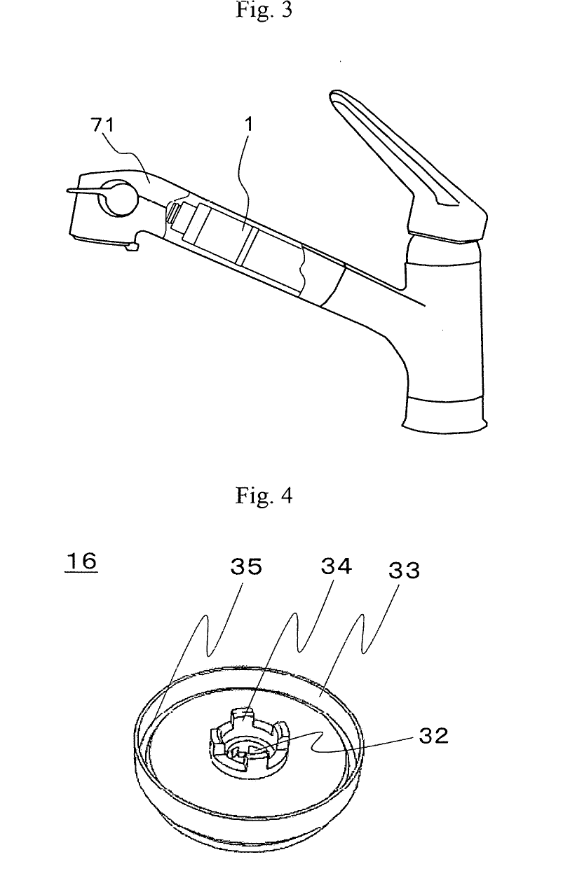

FIG. 1 is a longitudinally sectional conceptual view showing an embodiment of a water purifier cartridge according to the present invention. FIG. 2 is an enlarged view of an upstream part of the water purifier cartridge shown in FIG. 1. FIG. 3 is a partially cutaway sectional conceptual view showing an example of a state in which the water purifier cartridge according to the present invention has been attached to a water purifier.

As shown in FIG. 1, a water purifier cartridge 1 has a configuration in which an end portion bonding material 11, a filter material closing ring (filter material closing auxiliary material) 12, a correction cap (inner cylinder closing member) 13, an outer cylinder 14, an inner cylinder 15, an intermediate cap (cap member) 16, a hollow fiber membrane module 17, a connection cap 18, and an outlet cap 19 are disposed in order from the upstream side. The water purifier cartridge 1 has a structure in which those members are coupled with one another. An annular space 20 enclosed by the filter material closing ring 12, the outer cylinder 14, the inner cylinder 15, and the intermediate cap 16 is tightly filled with a granular filter material 21.

The outer cylinder 14 has a cylindrical shape, and the mesh size thereof is adjusted to allow water to pass through the outer cylinder 14 while not allowing the granular filter material 21 to pass through it. The mesh size of 20 μm to 50 μm is suitably used. Nonwoven fabric processed in the following manner is inexpensive and preferable. That is, nonwoven fabric using polyolefin-based thermally fusible fiber as a raw material is wound around a heated shaft a plurality of times so as to be formed into a cylindrical shape. The nonwoven fabric is cut to a predetermined length. However, the outer cylinder 14 is not limited thereto. An olefin-based material such as polypropylene may be melted and formed into a cylindrical shape by blow molding. Nonwoven fabric or mesh cloth may be welded or bonded to a cylindrical resin molded body having an opening in its outer circumferential surface. When the cylindrical resin molded body having an opening is molded, the nonwoven fabric or the mesh cloth may be inserted. The outer cylinder 14 is preferably made of nonwoven fabric. When the outer cylinder is made of nonwoven fabric, the thickness of the outer cylinder can be reduced as compared with a case where the outer cylinder has a configuration in which a meshed member is fixed to an inner circumferential surface of an outer case having an opening in its side surface. Thus, even when the water purifier cartridge has the same size, a larger amount of the granular filter material can be filled.

The thickness of the outer cylinder 14 formed out of the nonwoven fabric is preferably 0.5 mm to 1 mm. When the thickness is less than 0.5 mm, there arises a problem that the outer cylinder 14 may swell due to the granular filter material 21 filled therein or may subside due to water passing resistance during water passing. When the thickness exceeds 1 mm, the outer cylinder 14 pushes on the inner diameter side due to a restriction in the outer diameter of the cartridge. Thus, the filling amount of the granular filter material 21 is reduced. When the thickness is in the range of from 0.5 mm to 1 mm, there is no fear that the outer cylinder 14 may swell or subside, and there is no fear that the filling amount of the granular filter material 21 may be reduced undesirably.

A downstream side end portion (one end) of the outer cylinder 14 is firmly bonded to the intermediate cap (cap member) 16 by a hot melt bonding material. However, the bonding material is not limited thereto. The hot melt bonding material may be replaced by a polyurethane bonding material or a silicone bonding material.

In an upstream side end portion (the other end) of the outer cylinder 14, all the opening surface is integrally sealed off by the end portion bonding material 11 which is a hot melt bonding material. That is, on the other end side of the outer cylinder 14, the correction cap (inner cylinder closing member) 13, the filter material closing ring (filter material closing auxiliary member) 12, the outer cylinder 14 and the end portion boding material 11 are disposed integrally, and the end portion boding material 11 is disposed to cover all the opening surface at the other end of the outer cylinder 14. Thus, the granular filter material 21 is closed. Although all the opening surface at the other end of the outer cylinder 14 is covered with the end portion bonding material 11 in the embodiment of the present invention shown in FIG. 1, the invention is not limited to the embodiment as long as the inner cylinder closing member, the filter material closing auxiliary member, the outer cylinder and the end portion bonding material can integrally close the granular filter material. According to another embodiment, for example, all the opening surface at the other end of the outer cylinder is not covered with the end portion bonding material, but the end portion bonding material is disposed to close a boundary (gap) formed by the three members, that is, the outer cylinder, and the inner cylinder closing member and the filter material closing auxiliary member disposed in the opening portion at the other end of the outer cylinder, so that the granular filter material is closed not to leak out. Here, the form in which all the opening surface at the other end of the outer cylinder 14 is covered with the end portion bonding material 11 as shown in FIG. 1 is preferred because the granular filter material can be closed in a higher level, and the force with which the respective members can be fixed is enhanced, while the manufacturing process can be further simplified. In addition, the hot melt bonding material has high flowability when manufactured (when applied to the opening portion at the other end of the outer cylinder), and has a great effect of filling a gap. After the hot melt bonding material is hardened, the hardness thereof becomes high enough. Thus, even when the water purifier cartridge is installed or even when it is in use, the granular filter material can be surely prevented from leaking. However, the upstream end portion of the outer cylinder 14 does not have to be bonded by the hot melt bonding material. A polyurethane bonding material or a silicone bonding material may be used.

In the same manner as the outer cylinder 14, the inner cylinder 15 is also cylindrical, and the mesh size thereof is adjusted to allow water to pass through the inner cylinder 15 while not allowing the granular filter material 21 to pass through it. The mesh size of 20 μm to 50 μm is suitably used. Nonwoven fabric processed in the following manner is inexpensive and preferable. That is, nonwoven fabric using polyolefin-based thermally fusible fiber as a raw material is wound around a heated shaft a plurality of times so as to be formed into a cylindrical shape. The nonwoven fabric is cut to a predetermined length. However, the inner cylinder 15 is not limited thereto. An olefin-based material such as polypropylene may be melted and formed into a cylindrical shape by blow molding. Nonwoven fabric or mesh cloth may be welded or bonded to a cylindrical resin molded body having an opening in its outer circumferential surface. When the cylindrical resin molded body having an opening is molded, the nonwoven fabric or the mesh cloth may be inserted. The inner cylinder 15 is preferably made of a nonwoven fabric. When the inner cylinder is made of a nonwoven fabric, the thickness of the inner cylinder can be reduced as compared with a case where the inner cylinder has a configuration in which a meshed member is fixed to an inner circumferential surface of an inner case having an opening in its side surface. Thus, even when the water purifier cartridge has the same size, a larger amount of the granular filter material can be filled.

The thickness of the inner cylinder 15 formed out of the nonwoven fabric is preferably 0.5 mm to 2 mm. When the thickness is less than 0.5 mm, there arises a problem that the inner cylinder 15 may subside due to water passing resistance and pressure loss of the granular filter material during water passing. When the thickness exceeds 2 mm, the inner cylinder 15 pushes out on the inner diameter side to thereby reduce the filling amount of the granular filter material 21. When the thickness is in the range of from 0.5 mm to 2 mm, there is no fear that the inner cylinder 15 may subside, and there is no fear that the filling amount of the granular filter material 21 may be reduced undesirably.

A downstream side end portion (one end) of the inner cylinder 15 is fixed to an inner rib 34 of the intermediate cap (cap member) 16 by fitting. The fitting is performed in such a degree that the granular filter material can be prevented from leaking while axial alignment work, which will be described later, can be carried out.

A closing cylinder portion 41 of the correction cap (inner cylinder closing member) 13, which will be described later, is fitted to an upstream side end portion (the other end) of the inner cylinder 15, so that the granular filter material 21 can be prevented from entering an inner diameter side channel 22 of the inner cylinder 15.

The granular filter material 21 is made of granular activated carbon and a granular ion exchanger. As for the activated carbon, a plurality of kinds of activated carbon different in specific area, pore size distribution and grain size distribution are mixed at a predetermined ratio to optimize filtration performance and pressure loss. Of course, one kind of activated carbon may be used alone without being mixed with another. Needless to say, this is more advantageous in terms of cost. As the granular ion exchanger for removing soluble lead, a granular ion exchanger obtained by granulating powdery titanium silicate is used. However, the granular ion exchanger is not limited thereto. Even when granular or powdery aluminosilicate or titanium oxide is used other than titanium silicate, lead ions can be removed efficiently.

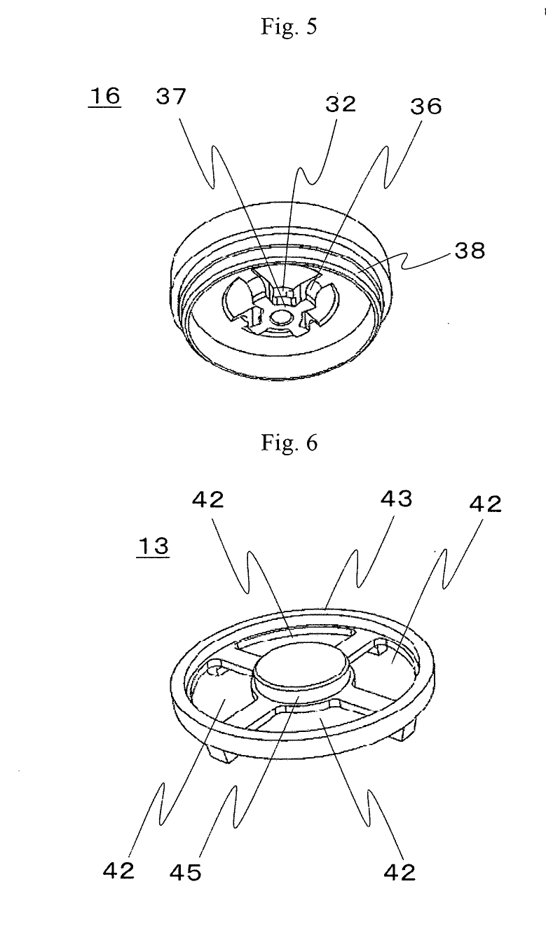

FIG. 4 is a perspective conceptual view of a form example of the intermediate cap (cap member) 16 provided in the water purifier cartridge 1 according to the present invention, viewed from the upstream side. FIG. 5 is a perspective conceptual view of the intermediate cap (cap member) 16 shown in FIG. 4, viewed from the downstream side. The intermediate cap 16 has a disc shape with an opening 32 at the center. In the intermediate cap 16, an outer rib 33 is provided erectly in a part to be coupled with the outer cylinder 14, and an inner rib 34 having notches is provided erectly at a part to be coupled with the inner cylinder 15. The outer rib 33 has a thickness of 0.3 mm to 1.5 mm thick and height of 1 mm to 4 mm. The outer rib 33 serves for aligning the central axis of the outer cylinder 14 with the central axis of the intermediate cap 16. The inner diameter of the outer rib 33 is substantially equal to the outer diameter of the outer cylinder 14, so as to also serve for preventing the hot melt bonding material 31 from pushing to the outside and being hardened therein. The opening 32 is disposed on the inner diameter side of the inner rib 34. The inner diameter of the inner rib 34 is substantially equal to the outer diameter of the inner cylinder 15. The inner cylinder 15 is fixed to the inner rib 34 by fitting. The fitting between the inner rib 34 and the inner cylinder 15 is performed in such a degree that the granular filter material can be prevented from leaking while axial alignment work, which will be described later, can be carried out. Thus, the inner diameter side channel 22 of the inner cylinder 15 communicates with the opening 32. That is, a channel from the granular filter material 21 to the hollow fiber membrane module 17 is secured.

Of the intermediate cap 16 (cap member), the part to be coupled with the outer cylinder 14 has a groove 35 formed to be 1 mm to 2 mm thick and 0.5 mm to 1 mm deep. The hot melt bonding material is reserved in the groove 35. The outer cylinder 14 is then inserted into the groove 35, and the hot melt bonding material is hardened. Thus, the intermediate cap 16 and the outer cylinder 14 have high adhesiveness.

A baffle plate 37 supported by four pillar portions 36 which are 1 mm to 4 mm high is provided on the hollow fiber membrane module side of the opening 32. The baffle plate 37 has a flat plate-like shape which is 1 mm to 2 mm thick and whose section has substantially the same shape as the opening 32. The baffle plate 37 protects the hollow fiber membrane bundle 51 from water spouting from the opening 32. The number of pillar portions 36 may be two or three, or five or more. The baffle plate 37 may have a bowl-like shape. If the baffle plate 37 has a bowl-like shape, the jet flow of water can be securely received. Thus, the effect of protecting the hollow fiber membrane bundle 51 can be enhanced.

A welding cylinder portion 38 is provided erectly in a surface of the intermediate cap 16 (cap member) coupled with the hollow fiber membrane module 17. A step provided on the outer circumferential side of the welding cylinder portion 38 can be engaged with a step provided in a casing 50, which will be described later, with no looseness. In the state where the steps are engaged with each other, a horn of an ultrasonic welding machine is brought into contact from the intermediate cap 16 side to apply vibrational energy to the steps while giving pressure thereto. Thus, the intermediate cap 16 and the casing 50 are welded with each other. Examples of welding methods may include a butt joint method, a step joint method, a share joint method, a bead joint method, etc. Any one of the methods may be used without special limitation. However, the share joint method is the most suitable because of its excellent water tightness and air tightness.

A noncrystalline resin having good affinity to a bonding material is preferably used as the material of the intermediate cap 16 (cap member). In consideration of safety, ABS resin (acrylonitrile, butadiene, or styrene) or polystyrene is preferred.

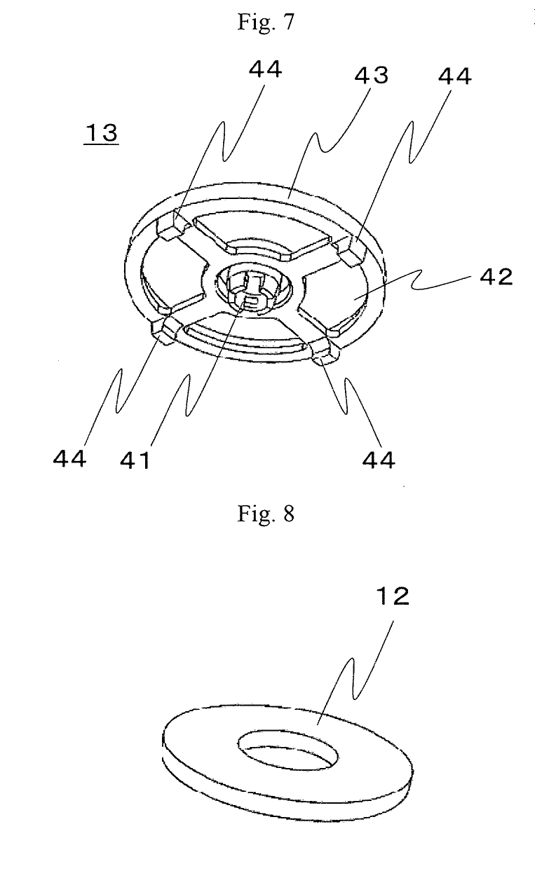

FIG. 6 is a perspective conceptual view of a form example of the correction cap (inner cylinder closing member) 13 of the water purifier cartridge 1 according to the present invention, viewed from the upstream side. FIG. 7 is a perspective conceptual view of the correction cap (inner cylinder closing member) 13 shown in FIG. 6, viewed from the downstream side. The correction cap 13 is a disc-like member having four granular filter material filling ports 42 radially, and a closing cylinder portion 41 protrudes on the downstream side at the center. A ring-like portion 43 formed with the same central axis as the closing cylinder portion 41 has an outer diameter substantially equal to the inner diameter of the outer cylinder 14. Thus, there is no fear that the ring-like portion 43 may spread out the outer cylinder 14 to increase the outer diameter of the cartridge, and there is no fear that the ring-like portion 43 may hinder formation of a raw water channel formed by an inner wall of a housing for storing the water purifier cartridge, and an outer wall of the water purifier cartridge.

A plurality of guide convex portions 44 are provided in the ring-like portion 43. Although the outer diameter of the ring-like portion 43 is substantially equal to the inner diameter of the outer cylinder 14, the guide convex portions 44 are first inserted into the outer cylinder 14 to thereby guide the ring-like portion 43. It is therefore possible to easily insert the correction cap (inner cylinder closing member) 13 into the outer cylinder 14.

The correction cap (inner cylinder closing member) 13 is fitted to the upstream side end portion of the inner cylinder 15 so as to prevent the granular filter material 21 from entering the inner diameter side channel 22 of the inner cylinder 15. At the same time, the ring-like portion 43 coaxial with the closing cylinder portion 41 contacts with the inner circumferential surface of the inner cylinder and the inner circumferential surface of the outer cylinder 14 so that the central axis of the outer cylinder 14 and the central axis of the inner cylinder 15 can coincide with each other inevitably. Thus, the annular space formed by the outer cylinder 14 and the inner cylinder 15 has a uniform width. In the state where the central axis of the outer cylinder 14 and the central axis of the inner cylinder 15 coincide with each other, the granular filter material can be filled from the four filling ports 42. Due to the uniform radial width of the annular space formed by the outer cylinder 14 and the inner cylinder 15, the flow of water becomes uniform. Thus, the granular filter material can exhibit sufficient filtration performance.

A ring-like recess 45 is provided in the correction cap (inner cylinder closing member) 13. The filter material closing ring (filter material closing auxiliary member) 12 which will be described later can be attached to the ring-like recess 45. The granular filter material 21 is filled to be as high as a lower surface of the ring-like recess 45 or to be a little higher than the lower surface, and the filter material closing ring 12 is then mounted thereon. In this manner, the filter material closing ring can be placed while being slightly deformed so that an unnecessary space cannot be formed on the downstream side of the ring-like recess 45.

A noncrystalline resin having good affinity to a bonding material is preferably used as the material of the correction cap (inner cylinder closing member) 13. In consideration of safety, ABS resin or polystyrene is preferred.

The correction cap (inner cylinder closing member) may have a form in which the outer edge thereof abuts against the inner circumferential surface of the outer cylinder and granular filter material filling ports are absent in the state where the correction cap (inner cylinder closing member) has been attached to the other end of the inner cylinder. However, it is preferable that the correction cap (inner cylinder closing member) has a form in which a gap occurs between the outer edge thereof and the inner circumferential surface of the outer cylinder in the state where the correction cap (inner cylinder closing member) has been attached to the other end of the inner cylinder, or the correction cap (inner cylinder closing member) has a form in which the outer edge thereof abuts against the inner circumferential surface of the outer cylinder and granular filter material filling ports are present in the state where the correction cap (inner cylinder closing member) has been attached to the other end of the inner cylinder, as shown in FIG. 1. When the correction cap (inner cylinder closing member) has any one of the aforementioned two forms, the granular filter material can be filled into the annular space from the gap between the outer edge of the correction cap (inner cylinder closing member) and the inner circumferential surface of the inner cylinder or from the granular filter material filling ports after the other end of the inner cylinder is closed with the correction cap (inner cylinder closing member) in the manufacturing process of the water purifier cartridge. Thus, the granular filter material can be prevented from intruding into the inner diameter side channel inside the inner cylinder. In addition, as described above, the central axis of the outer cylinder substantially coincides with the central axis of the inner cylinder so that the annular space formed by the outer cylinder and the inner cylinder has a uniform width in the radial direction of the water purifier cartridge, and the flow of water in the annular space filled with the granular filter material becomes uniform. From the viewpoint of this, it is more preferable that the correction cap (inner cylinder closing member) has, of the aforementioned two forms, the form in which the outer edge thereof abuts against the inner circumferential surface of the outer cylinder and the granular filter material filling ports are present in the state where the correction cap (inner cylinder closing member) has been attached to the other end of the inner cylinder. In the case where the correction cap (inner cylinder closing member) has the form in which a gap (opening portion) occurs between the outer edge thereof and the inner circumferential surface of the outer cylinder in the state where the correction cap (inner cylinder closing member) has been attached to the other end of the inner cylinder, it is preferable that the water purifier cartridge further includes a filter material closing auxiliary member for closing the gap (opening portion), and the opening surface at the other end of the outer cylinder is closed by the integration of the inner cylinder closing member, the filter material closing auxiliary member, the outer cylinder and the end portion bonding material, in order to more surely prevent the granular filter material from leaking from the annular space. Further, in the case where the correction cap (inner cylinder closing member) has the form in which the outer edge thereof abuts against the inner circumferential surface of the outer cylinder and the granular filter material filling ports are present in the state where the correction cap (inner cylinder closing member) has been attached to the other end of the inner cylinder, it is preferable that the water purifier cartridge further includes a filter material closing auxiliary member for closing the filling ports, and the opening surface at the other end of the outer cylinder is closed by the integration of the inner cylinder closing member, the filter material closing auxiliary member, the outer cylinder and the end portion bonding material, in order to more surely prevent the granular filter material from leaking from the annular space.

FIG. 8 is a perspective conceptual view of a form of the filter material closing ring (filter material closing auxiliary member) 12 of the water purifier cartridge 1, viewed from the upstream side. The filter material closing ring 12 having a ring-like shape is inserted into the aforementioned ring-like recess 45 while being compressed. The material of the filter material closing ring 12 is a crosslinked polyolefin foamed body, whose expansion ratio is preferably 5 to 50 times. When the expansion ratio is 5 to 50 times, the filter material closing ring 12 can be easily deformed by compression. Even when the granular filter material 21 is filled to be a little higher than the lower surface of the ring-like recess 45 as described above, and even when there may be irregularities in the uppermost portion of the filled granular filter material 21, the filter material closing ring 12 can be placed with slight deformation so that an unnecessary space cannot be formed on the downstream side of the ring-like recess 45. In addition, the position of the upper surface of the filter material closing ring is not changed. It is therefore possible to secure a space to which the end portion bonding material can be poured. The foamed body is not limited to polyolefin, but it may be a urethane foam, a silicon foam, an acrylic foam, a melamine sponge, or an EVA (ethylene-vinyl acetate copolymer resin) foam.

A modified olefin-based hot melt bonding material is used as the end portion bonding material 11. The modified olefin-based hot melt bonding material is melted by heating when the water purifier cartridge 1 is manufactured. The modified olefin-based hot melt bonding material thus provided with flowability is used. The modified olefin-based hot melt bonding material is poured from the opening in the upstream end portion of the outer cylinder 14 in the state where the granular filter material 21 has been filled from the filling ports 42 of the correction cap (inner cylinder closing member) 13 and the filter material closing ring (filter material closing auxiliary member) 12 has been inserted into the ring-like recess 45 of the correction cap 13. When the modified olefin-based hot melt bonding material is hardened due to temperature drop, the end portion bonding material 11 loses the flowability, and the end portion bonding material 11 is bonded with the outer cylinder 14, the correction cap 13 and the filter material closing ring 12 simultaneously so as to integrate them. In the embodiment of the water purifier cartridge according to the invention shown in FIG. 1, all the opening surface at the upstream end portion (the other end) of the outer cylinder 14 is closed integrally. Thus, there is no fear that the granular filter material 21 may leak out. In addition, the hardness of the end portion bonding material 11 which is a modified olefin-based hot melt bonding material is sufficiently high after it is hardened. Accordingly, when the water purifier cartridge is installed or when it is in use, there is no fear that the end portion bonding material 11 may be deformed. Thus, the granular filter material can be surely prevented from leaking. Further, the end portion bonding material 11 which is a modified olefin-based hot melt bonding material is inexpensive, and can be quickly hardened so that the waiting time for hardening can be shortened. Due to the inexpensive material and the good production efficiency, the manufacturing cost can be reduced.

However, the end portion bonding material 11 is not limited to the hot melt bonding material. A polyurethane bonding material or a silicone bonding material can be also used suitably. Each of the materials does not have to be heated. Accordingly, it is unnecessary to prepare a bonding material heating apparatus, and it is possible to reduce the equipment investment cost. A one-pack type silicone bonding material has high viscosity, and can be applied easily by a spatula. Therefore, there is no fear that the bonding material may drip to stain a table or a floor in a manufacturing site. Of each of the hot melt bonding material, the polyurethane bonding material and the silicone bonding material, some material does not elute any harmful substance even if the material contacts with water. Such a material is suitable as a water contact member in the water purifier and can secure safety of purified water. In terms of excellent handleability in the manufacturing of the water purifier cartridge, a two-liquid mixing type polyurethane bonding material is preferred as the polyurethane bonding material, and a one-pack type silicone bonding material is preferred as the silicone bonding material.

The hollow fiber membrane module 17 is constituted by the casing (hollow fiber membrane case) 50, the hollow fiber membrane bundle 51, a casting material (potting material) 52, and a protective net 53, as shown in FIG. 1. It is preferable that the water purifier cartridge 1 according to the present invention is provided with the hollow fiber membrane module 17 as in the embodiment of the water purifier cartridge of the present invention shown in FIG. 1. When the hollow fiber membrane module capable of removing particles, bacteria, etc. is provided, bacteria can be largely reduced from flowing out on the downstream side of the hollow fiber membrane module even if the bacteria enter the granular filter material and proliferate for some reason.

The casing 50 is a hollow fiber membrane case in which hollow fiber membranes are stored, and the hollow fiber membranes are fixed at one end thereof Inside the casing (hollow fiber membrane case) 50, the hollow fiber membrane bundle 51 in which the hollow fiber membranes have been folded in a U-shape is stored so that the folded side of the hollow fiber membrane bundle faces the intermediate cap (cap member) 16. An end portion of the hollow fiber membrane bundle is sealed and fixed at an end portion of the casing 50 by the casting material 52 filled among the hollow fiber membranes and between each hollow fiber membrane and the casing 50. The casting material 52 is partially cut and removed to make the hollow fiber membranes open toward the connection cap 18.

A part of the inner circumferential surface of the casing 50 is subjected to emboss processing to thereby prevent the casting material 52 from separating from the casing 50. During water passing, a load caused by water pressure is applied to the casting material 52. However, due to irregularities formed in the casting material 52 along irregularities of the embossed inner circumferential surface of the casing 50, the irregularities of the both catch each other to prevent the casting material 52 from separating or falling from the casing 50.

The casing 50 has a cylindrical shape. A step which can be engaged with the connection cap 18, which will be described later, is provided on the outer circumferential side of the end portion of the casing 50 sealed and fixed by the casting material 52, and a step which can be engaged with the aforementioned intermediate cap (cap member) 16 is formed on the outer circumferential side of the other end.

Hydrophilized polysulfone hollow fiber membranes are used as the hollow fiber membrane bundle 51. Polysulfone is superior in biological properties, heat resistance, chemical resistance, etc., and it is preferable to be applied to the water purifier. Other than polysulfone, polyacrylonitrile, polyphenylene sulfone, polyether sulfone, polyethylene, or polypropylene may be used for the hollow fiber membranes. A plurality of kinds of hollow fiber membranes made of different materials may be combined. When a hollow fiber membrane made of hydrophobic polyethylene or polypropylene is mixed, air mixed into water can be discharged efficiently. In order to catch bacteria, the pore size of the hollow fiber membranes is preferably 0.3 μm or less. It is preferable that each hollow fiber membrane is φ250 μm to 500 μm in outer diameter, φ100 μm to 340 μm in inner diameter, and 50 μm to 100 μm in membrane thickness. The hollow fiber membranes having dimensions within the aforementioned ranges can have sufficient strength. Accordingly, there is no fear that the hollow fiber membranes may be broken in a step of being folded in a U-shape or a step of being pushed into the casing 50 in the manufacturing of the hollow fiber membrane module.

It is preferable that the hollow fiber membrane bundle 51 is covered with the protective net 53. When the water purifier cartridge is used in an area where the pressure of tap water is extremely high, the flow of the water cannot be reduced sufficiently only by the aforementioned baffle plate 37, and the hollow fiber membranes may be thus pushed on the downstream side and broken or bent. However, due to the protective net 53 covering the hollow fiber membrane bundle 51, the shape of the hollow fiber membrane bundle 51 is prevented from falling into disorder. The hollow fiber membranes are prevented from being broken to reduce the filtration performance for turbidity.

Thermoplastic resin such as polyethylene terephthalate, polypropylene, polyethylene, etc. is inexpensive and suitable as the material of the protective net 53. The protective net 53 may have a form of woven/knit fabric such as mesh cloth other than nonwoven fabric.

Of polyurethane, epoxy resin, etc., a two-liquid mixing type one in which a main agent having flowability and a curing agent are mixed and hardened can be used suitably as the casting material (potting material) 52. Those may be solidified by a centrifugation method, a leave-to-stand method, etc.

The connection cap 18 is coupled with one end of the hollow fiber membrane module 17. In the state where the connection cap 18 has been engaged with the casing 50 without looseness, a horn of an ultrasonic welding machine is pushed to apply vibrational energy to the both while giving pressure thereto. Thus, the connection cap 18 and the casing 50 are welded with each other. Examples of welding methods may include a butt joint method, a step joint method, a share joint method, a bead joint method, etc. Any one of the methods may be used without special limitation. However, the share joint method is the most suitable because of its excellent water tightness and air tightness. The other end of the connection cap 18 is coupled with the outlet cap 19 which will be described later.

The outlet cap 19 has a cylindrical shape, in which the outer diameter and the inner diameter change at the center. The outlet cap 19 is coupled with the connection cap 18 on the inner circumferential side at the larger-diameter end. At the other smaller-diameter end, a purified water outlet 62 is open, and an O-ring 63 is mounted in an annular groove near the tip of the purified water outlet 62. Since the outlet cap 19 is connected to a member on the downstream side of purified water through the O-ring 63, there is no fear that the purified water is mixed with the raw water (such as tap water which has not been purified).

Although ABS resin, polyacetal, polycarbonate or polystylene having high dimensional accuracy in molding may be used as the material of the outlet cap 19, polyethylene or polypropylene which is comparatively soft can be preferably used. When polyethylene or polypropylene is used, an undercut part can be forcedly extracted from a mold easily, and the mold producing cost can be reduced. In addition, since polyethylene or polypropylene is comparatively soft, fitting can be easily performed in the manufacturing of the cartridge, so that the productivity can be improved.

The water purifier cartridge 1 configured as described above is used suitably as a cartridge which is built in a water purifier built in a faucet as shown in FIG. 3. A flow channel switching valve is incorporated in a head portion 71 of the water purifier built in the faucet so as to be able to change over between a water purification state in which tap water is purified and a raw water state in which the tap water is discharged as it is.

When the flow channel switching valve is set in the water purification state and the faucet is opened, tap water flows into the outer circumferential side of the water purifier cartridge 1. The tap water first passes through the outer cylinder 14, and then passes through the granular filter material 21 and the inner cylinder 15 sequentially. At this time, free residual chlorine in the tap water is decomposed, and at the same time, volatile organic substances in the tap water are adsorbed and removed. Since no binder for molding is added to the granular filter material 21, the filtration performance corresponding to the volume of the granular filter material can be exhibited. Since the inner cylinder closing member contacts with the inner circumferential surface of the outer cylinder and the central axis of the outer cylinder is aligned with the central axis of the inner cylinder, the annular space formed by the outer cylinder and the inner cylinder has a uniform width so that the flow of the water becomes uniform. Thus, the filtration performance of the granular filter material can be exhibited sufficiently. Since there is not a large difference in length between the outer cylinder and the inner cylinder, there arises no problem that the granular activated carbon filled into a part different in length between the outer cylinder and the inner cylinder cannot be used effectively. Since nonwoven fabric alone is used for each of the inner cylinder and the outer cylinder, each of the inner cylinder and the outer cylinder has a sufficiently reduced thickness. Thus, the filling amount of the granular filter material is so large that high filtration performance can be exhibited.

Next, the water passes through the inner diameter side channel 22 of the inner cylinder 15 and the opening 32 of the intermediate cap 16, and reaches the hollow fiber membrane bundle 51. At this time, the water flowing into the casing 50 from the inner diameter channel 22 hits on the baffle plate 37 once. Therefore, the pressure of the water is relaxed. The water flows from the outer diameter side of each hollow fiber membrane toward the inner diameter side of the same so that suspended substances or bacteria in the tap water can be caught by the hollow fiber membranes. The purified water passed through the hollow fiber membranes passes through the connection cap 18 and the outlet cap 19 sequentially. Then the water passing through the flow channel switching valve of the head portion 71 is discharged as purified water from the faucet. A user can obtain tasty and safe purified water.

The end portion bonding material has flowability when manufactured (when applied to the opening portion at the other end of the outer cylinder) so that a gap can be firmly filled therewith in the boundaries among the inner cylinder closing member, the filter material closing auxiliary member and the outer cylinder. The end portion bonding material hardened after that loses the flowability so that the granular filter material can be surely prevented from leaking. Therefore, the granular filter material can be surely prevented from leaking when the cartridge is installed or when it is in use.

Since the water purifier cartridge according to the present invention is compact, it can be used suitably particularly in a water purifier built in a faucet. Here, the water purifier built in a faucet is mounted with the water purifier cartridge removably. In addition, the water purifier cartridge according to the present invention may be also used in a water purifier other than the water purifier built in a faucet. The water purifier other than the water purifier built in a faucet is also mounted with the water purifier cartridge removably.

### EXAMPLES

### Example 1

Polyolefin-based thermally fusible fiber nonwoven fabric which was 30 mm in inner diameter and 0.7 mm in thickness and which had been heated and molded was used as the outer cylinder. Nonwoven fabric which was 8 mm in outer diameter and 1 mm in thickness and which was similar to that of the outer cylinder was used as the inner cylinder. One end of the outer cylinder was bonded with the intermediate cap of the hollow fiber membrane module, and one end of the inner cylinder was fitted therein. Next, the correction cap was mounted on the opening portion at the other end of the outer cylinder. The distance between the ring-like recess of the correction cap and the intermediate cap was 71 mm, and 46.6 mL of the granular filter material was filled. After the filter material closing ring was placed, 0.8 mL of a melted hot melt bonding material was poured into the opening portion at the other end of the outer cylinder, and hardened. ARON MELT manufactured by Toagosei Co., Ltd. was used as the hot melt bonding material.

Even when the water purifier cartridge configured thus was installed or even during water passing therein, the granular filter material did not leak from the water purifier cartridge. A chloroform filtration capability test at a filtration flow rate of 2 L/min was performed based on Japanese Industrial Standard JIS S 3201:2010. The removal ratio reached 80% at 1,240 L.

### Example 2

Polyolefin-based thermally fusible fiber nonwoven fabric which was 30 mm in inner diameter and 0.7 mm in thickness and which had been heated and molded was used as the outer cylinder. Nonwoven fabric which was 8 mm in outer diameter and 1 mm in thickness and which was similar to that of the outer cylinder was used as the inner cylinder. One end of the outer cylinder was bonded with the intermediate cap of the hollow fiber membrane module, and one end of the inner cylinder was fitted therein. Next, the correction cap was mounted on the opening portion at the other end of the outer cylinder. The distance between the ring-like recess of the correction cap and the intermediate cap was 71 mm, and 46.6 mL of the granular filter material was filled. After the filter material closing ring was placed, 0.8 mL of a two-liquid curing type polyurethane bonding material immediately after a main agent and a curing agent were mixed was poured into the opening portion at the other end of the outer cylinder, and hardened. POLYMEDICA manufactured by Sanyo Chemical Industries, Ltd. was used as the two-liquid curing type polyurethane bonding material.

Even when the water purifier cartridge configured thus was installed or even during water passing therein, the granular filter material did not leak from the water purifier cartridge. A chloroform filtration capability test at a filtration flow rate of 2 L/min was performed based on Japanese Industrial Standard JIS S 3201:2010. The removal ratio reached 80% at 1,240 L.

### Example 3

Polyolefin-based nonwoven fabric which was 0.2 mm thick and which had been wound around an ABS resin molded component which was 30.5 mm in outer diameter and 28.5 in inner diameter was used as the outer cylinder. Polyolefin-based nonwoven fabric which was 0.2 mm thick and which had been wound around an ABS resin molded component which was 9 mm in outer diameter and 6 mm in inner diameter was used as the inner cylinder. The molded components included openings in their side surfaces respectively. One end of the outer cylinder was bonded with the intermediate cap of the hollow fiber membrane module, and one end of the inner cylinder was fitted therein. Next, the correction cap was mounted on the opening portion at the other end of the outer cylinder. The distance between the ring-like recess of the correction cap and the intermediate cap was 71 mm, and 39.5 mL of the granular filter material was filled. After the filter material closing ring was placed, 0.8 mL of a melted hot melt bonding material was poured, and hardened. ARON MELT manufactured by Toagosei Co., Ltd. was used as the hot melt bonding material.

Even when the water purifier cartridge configured thus was installed or even during water conduction therein, the granular filter material did not leak from the water purifier cartridge. A chloroform filtration capability test at a filtration flow rate of 2 L/min was performed based on Japanese Industrial Standard JIS S 3201:2010. The removal ratio reached 80% at 970 L.

### Comparative Example 1

Polyolefin-based thermally fusible fiber nonwoven fabric which was 30 mm in inner diameter and 0.7 mm in thickness and which had been heated and molded was used as the outer cylinder. Nonwoven fabric which was 8 mm in outer diameter and 1 mm in thickness and which was similar to that of the outer cylinder was used as the inner cylinder. One end of the outer cylinder was bonded with the intermediate cap of the hollow fiber membrane module, and one end of the inner cylinder was fitted therein. A first closing member for closing only the inner cylinder was placed, and 47.1 mL of the granular filter material was filled. After a second closing member was then placed, the other end portion of the outer cylinder was folded inward at the edge portion of the second closing member, and heated by an iron to make a form in which the other end portion of the outer cylinder was pressed and fixed onto the upper surface of the second closing member. The distance between the upstream side surface of the first closing member and the downstream side surface of the second closing member was 10 mm.

When the water purifier cartridge configured thus was installed, a small amount of the granular filter material leaked from the water purifier cartridge. A chloroform filtration capability test at a filtration flow rate of 2 L/min was performed based on Japanese Industrial Standard JIS S 3201:2010. The removal ratio reached 80% at 1,007 L.

The present invention has been described in detail and with reference to its specific embodiment. However, it is obvious for those skilled in the art that various changes or modifications can be made on the present invention without departing from its spirit and scope. The present application is based on a Japanese patent application (Japanese Patent Application No. 2016-029882) filed on Feb. 19, 2016, the contents of which are incorporated herein by reference.

The present invention can be applied to general water purifiers including a water purifier built in a faucet, a faucet direct connection type water purifier, a stationary type water purifier, a pot type water purifier, an under-sink type water purifier, etc. However, the present invention is not limited to those.

### DESCRIPTION OF REFERENCE NUMERALS AND SIGNS

1 water purifier cartridge
11 end portion bonding material
12 filter material closing ring (filter material closing auxiliary member)
13 correction cap (inner cylinder closing member)
14 outer cylinder
15 inner cylinder
16 intermediate cap (cap member)
17 hollow fiber membrane module
18 connection cap
19 outlet cap
20 annular space
21 granular filter material
22 inner diameter side channel
32 opening
33 outer rib
34 inner rib
35 groove
36 pillar portion
37 baffle plate
38 welding cylinder portion
41 closing cylinder portion
42 filling port
43 ring-like portion
44 guide convex portion
45 ring-like recess
50 casing (hollow fiber membrane case)
51 hollow fiber membrane bundle
52 casting material (potting material)
53 protective net
62 purified water outlet
63 O-ring
71 head portion

1. A water purifier cartridge comprising:
a granular filter material;
an inner cylinder which supports the granular filter material from the inside and allows water to pass through but does not allow the granular filter material to pass through;
an outer cylinder which supports the granular filter material from the outside and allows water to pass through but does not allow the granular filter material to pass through;
a cap member which couples one end of the inner cylinder with one end of the outer cylinder and has an opening communicating with an inner diameter side channel inside the inner cylinder;
an inner cylinder closing member which closes the other end of the inner cylinder; and
an end portion bonding material which bonds and fixes the inner cylinder closing member to the outer cylinder; wherein:
the inner cylinder closing member, the outer cylinder and the end portion bonding material are disposed to integrally close an opening surface at the other end of the outer cylinder.

2. The water purifier cartridge according to claim 1, wherein:
the inner cylinder closing member contacts with an inner circumferential surface of the outer cylinder and has a filling port of the granular filter material.

3. The water purifier cartridge according to claim 2, further comprising:
a filter material closing auxiliary member which closes the filling port; wherein:
the inner cylinder closing member, the filter material closing auxiliary member, the outer cylinder and the end portion bonding material are disposed to integrally close the opening surface at the other end of the outer cylinder.

4. The water purifier cartridge according to claim 3, wherein the filter material closing auxiliary member is a foamed body.

5. The water purifier cartridge according to claim 1, wherein the end portion bonding material is a hot melt bonding material.

6. The water purifier cartridge according to claim 1, wherein the end portion bonding material is a polyurethane bonding material.

7. The water purifier cartridge according to claim 1, wherein the end portion bonding material is a silicone bonding material.

8. The water purifier cartridge according to claim 1, further comprising:
a hollow fiber membrane bundle in which hollow fiber membranes are bundled in a U-shape; and
a hollow fiber membrane case which stores the hollow fiber membrane bundle and fixes the hollow fiber membranes at one end of the hollow fiber membrane; wherein:
the other end of the hollow fiber membrane case and the cap member are liquid-tightly coupled with each other.

9. The water purifier cartridge according to claim 1, wherein the inner cylinder is made of a nonwoven fabric.

10. The water purifier cartridge according to claim 1, wherein the outer cylinder is made of a nonwoven fabric.

11. The water purifier cartridge according to claim 1, wherein a thickness of the nonwoven fabric forming the outer cylinder is 0.5 to 1 mm.

12. A water purifier cartridge for a water purifier built in a faucet, comprising a water purifier cartridge according to claim 1.

13. A water purifier built in a faucet, wherein the water purifier cartridge for a water purifier built in a faucet according to claim 12 is disposed removably.

14. A water purifier wherein the water purifier cartridge according to claim 1 is disposed removably.
